(19) United States
(12) Patent Application Publication
(10) Pub. No.: US 2025/0087394 A1
(43) Pub. Date: Mar. 13, 2025

(54) NEODYMIUM-IRON-BORON MAGNET MATERIAL AND PREPARATION METHOD THEREFOR AND APPLICATION THEREO

(71) Applicant: FUJIAN GOLDEN DRAGON RARE-EARTH CO., LTD., Fujian (CN)

(72) Inventors: Weiguo MOU, Fujian (CN); Chen WANG, Fujian (CN); Zhigao HUANG, Fujian (CN); Gang FU, Fujian (CN); Deqin XU, Fujian (CN)

(21) Appl. No.: 18/721,783

(22) PCT Filed: Nov. 4, 2022
(86) PCT No.: PCT/CN2022/129742

§ 371 Date: Jun. 19, 2024

(30) Foreign Application Priority Data
Apr. 29, 2022 (CN) 202210476515.3

(51) Int. Cl. H01F 1/057; C22C 38/00; C22C 38/06; C22C 38/10; C22C 38/14; C22C 38/16; H01F 1/055; H01F 41/02

(52) U.S. Cl. CPC H01F 1/0577; C22C 38/002; C22C 38/005; C22C 38/06; C22C 38/10; C22C 38/14; C22C 38/16; H01F 1/0553; H01F 41/0293

(57) ABSTRACT

The invention discloses a neodymium-iron-boron magnet material, a preparation method, and use thereof. The neodymium-iron-boron magnet material of the invention comprises a nanocrystalline Cu-rich phase located in an intergranular triangular zone, wherein: the nanocrystalline Cu-rich phase consists of elements TM, RE, Cu and Ga at an atom ratio of TM:RE:Cu:Ga=(1-20):(20-55):(25-70):(1-15); and a volume percentage of the nanocrystalline Cu-rich phase in the intergranular triangular zone is 4-12%, wherein TM comprises Fe and/or Co, and RE is a rare earth element. The neodymium-iron-boron magnet material of the present invention can improve the intrinsic coercivity and reduce the cost without using heavy rare earth elements or using a small amount of heavy rare earth elements, while maintaining the performances of higher remanence, magnetic energy product and squareness.

### FIELD OF THE INVENTION

The invention specifically relates to a neodymium-iron-boron magnet material, a preparation method, and use thereof.

### BACKGROUND OF THE INVENTION

The neodymium-iron-boron permanent magnet materials with Nd₂Fe₁₄B as the main component have higher remanence, coercivity and maximum magnetic energy product.

They have excellent comprehensive magnetic properties and are widely used in high-tech fields such as computers, communications, and national defense. Motors are the main application field of neodymium-iron-boron permanent magnets, and their application in hybrid electric vehicles (HEVs) is particularly eye-catching. The drive motor is the core component of new energy vehicles, so the neodymium-iron-boron magnet materials with higher coercivity used in the drive motor have broad application prospects. At the same time, the improvement of the performance of drive motors forces the improvement of the performance of the neodymium-iron-boron magnet materials with higher coercivity to meet the magnet performance requirements of manufacturers for drive motor.

Adding a certain amount of heavy rare earth elements Tb and Dy to the sintered neodymium-iron-boron master alloy can effectively improve the coercivity of the magnet. However, Tb and Dy are strategic metals with limited reserves and high prices. In addition, while improving coercivity, the remanence and magnetic energy product are sacrificed. Therefore, how to improve the intrinsic coercivity without using heavy rare earths or using less heavy rare earths is of great significance for reducing the cost of neodymium-iron-boron magnet materials.

### SUMMARY OF THE INVENTION

The technical problem solved by the present invention is to overcome the defects that the existing technology relies on heavy rare earth elements to improve the coercivity of neodymium-iron-boron magnet materials, which results in higher cost, limited sources of raw materials, and reduced remanence and magnetic energy product. The invention provides a neodymium-iron-boron magnet material, a preparation method, and use thereof. The neodymium-iron-boron magnet material of the present invention can improve the intrinsic coercivity and reduce the cost without using heavy rare earth elements or using a small amount of heavy rare earth elements, while maintaining the performances of higher remanence, magnetic energy product and squareness.

The present invention solves the above technical problem through the following technical solutions:

The invention provides a neodymium-iron-boron magnet material, comprising a nanocrystalline Cu-rich phase located in an intergranular triangular zone, wherein: the nanocrystalline Cu-rich phase consists of elements TM, RE, Cu and Ga at an atom ratio of TM:RE:Cu:Ga=(1-20):(20-55):(25-70):(1-15); and a volume percentage of the nanocrystalline Cu-rich phase in the intergranular triangular zone is 4-12%, wherein TM comprises Fe and/or Co, and RE is a rare earth element.

In some preferred embodiments of the invention, the TM is Fe and/or Co.

In the nanocrystalline Cu-rich phase, the TM has an atom percentage of preferably 5-15%, more preferably 7%, 10%, 12%, 13%, 14% or 15%.
and/or, in the nanocrystalline Cu-rich phase, the RE has an atom percentage of preferably 25-55%, more preferably 26%, 32%, 34%, 38%, 39%, 44%, 50%.
and/or, in the nanocrystalline Cu-rich phase, the Cu has an atom percentage of preferably 30-60%, more preferably 35-55%, such as 45%, 58%, 52%, 33%, 42% or 31%.
and/or, in the nanocrystalline Cu-rich phase, the Ga has an atom percentage of 1-10%, preferably 2%, 4%, 7%, 9% or 10%,
or, the nanocrystalline Cu-rich phase consists of Fe₅₋₁₅RE₂₅₋₄₀Cu₄₅₋₆₀Ga₂₋₉, wherein numbers are atomic percentages of respective elements;
or, the nanocrystalline Cu-rich phase consists of Fe₁₀₋₁₅RE₃₀₋₅₀Cu₃₀₋₄₄Ga₇₋₁₀, wherein numbers are atomic percentages of respective elements;

In some preferred embodiments of the invention, the nanocrystalline Cu-rich phase consists of Fe₇RE₃₉Cu₄₅Ga₉, wherein numbers represent atomic percentages of respective elements.

In some preferred embodiments of the invention, the nanocrystalline Cu-rich phase consists of Fe₁₂RE₂₆Cu₅₈Ga₄, wherein numbers represent atomic percentages of respective elements.

In some preferred embodiments of the invention, the nanocrystalline Cu-rich phase consists of Fe₁₄RE₃₂Cu₅₂Ga₂, wherein numbers represent atomic percentages of respective elements.

In some preferred embodiments of the invention, the nanocrystalline Cu-rich phase consists of Fe₁₀RE₅₀Cu₃₃Ga₇, wherein numbers represent atomic percentages of respective elements.

In some preferred embodiments of the invention, the nanocrystalline Cu-rich phase consists of Fe₁₃RE₃₈Cu₄₂Ga₇, wherein numbers represent atomic percentages of respective elements.

In some preferred embodiments of the invention, the nanocrystalline Cu-rich phase consists of Fe₁₄RE₃₄Cu₄₂Ga₁₀, wherein numbers represent atomic percentages of respective elements.

In the invention, the volume percentage of the nanocrystalline Cu-rich phase in the intergranular triangular zone is preferably 4-9%, for example 4.5%, 4.2%, 6.1%, 6.6%, 7.5%, 7.8% or 8.5%.

Those skilled in the field know that the intergranular triangular zone refers to an intergranular phase formed between three crystal grains.

The invention further provides a neodymium-iron-boron magnet material, comprising the following components of Cu: 0.20-0.9 wt %; and Ga: 0.02-0.35 wt %, wherein contents of Cu and Ga satisfy 2≤Cu/Ga≤15, wherein the Cu and the Ga represent a mass percentage of Cu and Ga respectively, the percentages are mass percentages in the neodymium-iron-boron magnet material, and a total content of all components in the neodymium-iron-boron magnet material is 100%.

In the invention, the Cu has a content of preferably 0.25-0.8 wt %, such as 0.25 wt %, 0.35 wt %, 0.50 wt %, 0.60% or 0.75%.

In the invention, the Ga has a content of preferably 0.05-0.2 wt %, such as 0.10 wt %, 0.12 wt %, 0.16 wt % or 0.18 wt %.

In the invention, the neodymium-iron-boron magnet material generally further comprises a rare earth element RE.

Wherein, the mass percentage of the RE in the neodymium-iron-boron magnet material can be conventional in the art, preferably 28-35 wt %, such as 30 wt %, 30.2 wt %, 31 wt %, 32 wt % or 33 wt %.

Wherein, the RE generally includes at least Nd, and preferably further includes Nd and Pr.

When the RE includes Nd and Pr, the content of Nd can be conventional in the art, preferably 23-32 wt %, such as 23.25 wt %, 24 wt % or 24.75 wt %.

When the RE includes Nd and Pr, the content of Pr can be conventional in the art, preferably 7-9 wt %, such as 7.75 wt %, 8 wt % or 8.25 wt %.

In some preferred embodiments of the invention, the RE preferably further comprises Dy.

Wherein, the Dy has a content of preferably 0.1-0.5 wt %, more preferably 0.1-0.3 wt %, for example 0.2 wt %.

In the invention, the neodymium-iron-boron magnet material generally further includes Al.

Wherein, the Al content may be conventional in the art, preferably 0.05-2 wt %, more preferably 0.1-1.5 wt %, such as 0.3 wt %, 0.5 wt %, 0.8 wt % or 1.0 wt %.

In the present invention, the neodymium-iron-boron magnet material generally further includes B.

Wherein, the content of B can be conventional in the art, preferably 0.85-1.1 wt %, such as 0.95 wt %, 0.96 wt % or 0.98 wt %.

In the present invention, the neodymium-iron-boron magnet material generally further includes Fe.

Wherein, the content of Fe can be conventional in the art, preferably 60-70 wt %, more preferably 62-69 wt %, such as 63.7 wt %, 65.01 wt %, 65.66 wt %, 67.17 wt %, 67.27 wt %, 67.07 wt % or 67.32 wt %.

In the present invention, the neodymium-iron-boron magnet material preferably further includes Co.

Wherein, the content of Co can be conventional in the art, preferably 0.1-3 wt %, such as 0.5 wt %, 0.8 wt % or 1.0 wt %.

In the present invention, the neodymium-iron-boron magnet material preferably further includes Zr.

Wherein, the content of Zr can be conventional in this field, preferably 0.05-1 wt %, such as 0.1 wt %.

In the present invention, the neodymium-iron-boron magnet material preferably further includes Ti.

Wherein, the content of Ti can be conventional in the art, preferably 0.05-1 wt %, such as 0.1 wt %.

In the present invention, the neodymium-iron-boron magnet material preferably further includes Nb.

Wherein, the content of Nb can be conventional in the art, preferably 0.1-0.3 wt %, such as 0.15 wt %, 0.18 wt % or 0.20 wt %.

In a preferable embodiment of the invention, the neodymium-iron-boron magnet material comprises the following components by mass % of Nd: 24.75%, Pr: 8.25%, Al: 1.00%, Cu: 0.25%, Ga: 0.12%, Co: 0.80%, Nb: 0.15%, B: 0.98% and Fe: 63.7%.

In a preferable embodiment of the invention, the neodymium-iron-boron magnet material comprises the following components by mass % of Nd: 24.00%, Pr: 8.00%, Al: 0.80%, Cu: 0.35%, Ga: 0.16%, Co: 0.50%, Zr: 0.10%, Ti: 0.10%, B: 0.98% and Fe: 65.01%.

In a preferable embodiment of the invention, the neodymium-iron-boron magnet material comprises the following components by mass % of Nd: 23.25%, Pr: 7.75%, Al: 0.50%, Cu: 0.50%, Ga: 0.18%, Co: 1.00%, Nb: 0.20%, B: 0.96% and Fe: 65.66%.

In a preferable embodiment of the invention, the neodymium-iron-boron magnet material comprises the following components by mass % of Nd: 30.00%, Dy: 0.20%, Al: 0.30%, Cu: 0.50%, Ga: 0.10%, Co: 0.50%, Nb: 0.18%, B: 0.95% and Fe: 67.27%.

In a preferable embodiment of the invention, the neodymium-iron-boron magnet material comprises the following components by mass % of Nd: 30.00%, Dy: 0.20%, Al: 0.30%, Cu: 0.60%, Ga: 0.10%, Co: 0.50%, Nb: 0.18%, B: 0.95% and Fe: 67.17%.

In a preferable embodiment of the invention, the neodymium-iron-boron magnet material comprises the following components by mass % of Nd: 30.00%, Dy: 0.20%, Al: 0.30%, Cu: 0.50%, Ga: 0.05%, Co: 0.50%, Nb: 0.18%, B: 0.95% and Fe: 67.32%.

In a preferable embodiment of the invention, the neodymium-iron-boron magnet material comprises the following components by mass % of Nd: 30.00%, Dy: 0.20%, Al: 0.30%, Cu: 0.75%, Ga: 0.05%, Co: 0.50%, Nb: 0.18%, B: 0.95% and Fe: 67.07%.

Those skilled in the field know that Nd is neodymium, Fe is iron, B is boron, Tb is terbium, Dy is dysprosium, Co is cobalt, Cu is copper, Ga is gallium, Al is aluminum, Mn is manganese, Zr is zirconium, Ti is titanium, and Nb is niobium.

The invention further provides a preparation method for a neodymium-iron-boron magnet material, comprising following steps of preparing a magnet blank from the respective components of the neodymium-iron-boron magnet material as described above; and subjecting the magnet blank to an aging treatment to achieve the neodymium-iron-boron magnet material, wherein the aging treatment comprises a primary aging and a secondary aging, and the secondary aging is performed at a temperature of 440-480° C.

In the present invention, the preparation method of the magnet blank can be conventional in the art. Generally, it can be achieved by subjecting the respective components for the neodymium-iron-boron magnet material to smelting, casting, pulverization, shaping and sintering in turn.

Wherein, the smelting temperature may be conventional in the art, preferably 1550° C. or less, more preferably 1480-1550° C., such as 1520° C.

Wherein, the smelting is preferably carried out in a vacuum environment, and the absolute pressure of the vacuum environment is preferably 2×10⁻² Pa-8×10⁻² Pa, such as 5×10⁻² Pa.

Wherein, the casting method may be conventional in this field, preferably a rapid solidification casting method.

Wherein, the casting temperature may be conventional in the art, preferably 1390-1460° C., such as 1410° C.

Wherein, the thickness of the alloy casting sheet obtained after the casting can be conventional in this field, preferably 0.25-0.40 mm.

Wherein, the pulverization method can be conventional in this field, and preferably includes hydrogen decrepitation pulverization and jet mill pulverization in sequence.

The hydrogen decrepitation pulverization generally includes hydrogen absorption, dehydrogenation and cooling treatment.

In the hydrogen decrepitation pulverization, the hydrogen pressure during the hydrogen absorption process can be conventional in this field, preferably 0.05-0.12 MPa, more preferably 0.085 MPa.

In the hydrogen decrepitation pulverization, the dehydrogenation can be carried out by conventional methods in this field, preferably by raising the temperature under vacuum conditions. The temperature after heating can be conventional in the art, preferably 300-600° C., such as 500° C.

The atmosphere used for the jet mill pulverization can be conventional in this field, and preferably the oxidizing gas content is not higher than 100 ppm.

In the jet mill pulverization, the oxidizing gas can be conventional in the art and generally includes oxygen and/or water vapor.

The pressure in the grinding chamber during the jet mill pulverization can be conventional in this field, preferably 0.5-1 MPa, more preferably 0.7 MPa.

The particle size D50 after being pulverized by the jet mill pulverization can be conventional in this field, preferably 3-6 μm, such as 4.2 μm.

The particle size distribution after the jet mill pulverization can be conventional in this field, preferably D90/D10 is 3-5, more preferably 3.7.

Wherein, the shaping method can be conventional in this field, and is generally magnetic field molding.

The intensity of the magnetic field in the magnetic field shaping can be conventional in this field, and is preferably 1.8-2.5 T.

Preferably, the magnetic field shaping is performed in a protective atmosphere. The protective atmosphere may be conventional in the art, such as nitrogen.

Wherein, preferably, a lubricant is added to the pulverized powder before the shaping.

Wherein, the lubricant can be conventional in this field, preferably zinc stearate.

The added amount of the lubricant can be conventional in the art, preferably 0.05-0.15%, more preferably 0.10%, wherein the percentage is the mass percentage of the lubricant and the pulverized powder.

Wherein, the sintering can be carried out using conventional methods in the art, preferably in a vacuum environment.

The vacuum condition can be conventional in the art, generally the absolute pressure is not higher than 10⁻² Pa, and more preferably is 5×10⁻³ Pa.

Wherein, the sintering temperature may be conventional in the art, preferably 1000-1100° C., such as 1085° C.

Wherein, the sintering time can be conventional in the art, preferably 4-8 hours, such as 6 hours.

In the present invention, the primary aging can be carried out by conventional methods in this field, and generally heating is sufficient.

In the present invention, the temperature of the primary aging is preferably 800-1200° C., and more preferably 900° C.

In the present invention, the primary aging time is preferably 2-4 hours, more preferably 3 hours.

In the present invention, preferably, after the primary aging is completed, the material is cooled to room temperature and then the secondary aging is performed.

In the present invention, the temperature of the secondary aging treatment is preferably 440° C., 450° C., 460° C. or 480° C.

In the present invention, the time of the secondary aging treatment is preferably 2-4 hours, more preferably 3 hours.

The invention further provides a neodymium-iron-boron magnet material prepared by the above preparation method.

The invention further provides use of the neodymium-iron-boron magnet material as described above as an electronic component in a motor.

In the present invention, the motor is preferably a new energy vehicle drive motor, an air conditioning compressor or an industrial servo motor, a wind turbine, an energy-saving elevator or a speaker assembly.

On the basis of common sense in the field, the above preferred conditions can be combined arbitrarily to obtain preferred examples of the present invention.

The reagents and raw materials used in the present invention are all commercially available.

The positive progressive effects of the present invention are as follows: In the case where the use of heavy rare earth elements is reduced or no heavy rare earth elements are added, the neodymium-iron-boron magnet material of the present invention still has significantly improved coercivity and remanence. The neodymium-iron-boron magnet material of the present invention has lower cost and broad prospects for large-scale production. As for the neodymium-iron-boron magnet material of the present invention, its remanence can be higher than 13 kGs, or even as high as 14.38 kGs, its intrinsic coercivity can be higher than 20.10 kOe, or even as high as 26.20 kOe; its maximum magnetic energy product can be higher than 40 MGOe, even as high as 49.23 MGOe; and its squareness can be no less than 0.98, or even reach 0.99.

### BRIEF DESCRIPTION OF THE DRAWINGS

FIG. 1 shows the TEM pattern of the neodymium-iron-boron magnet material of Example 1;

FIG. 2 shows the TEM-EDS pattern of the neodymium-iron-boron magnet material of Example 1, wherein the arrow points to the nanocrystalline Cu-rich phase; and

FIG. 3 shows the high-resolution TEM pattern of the neodymium-iron-boron magnet material of Example 1.

### DETAILED DESCRIPTION OF THE INVENTION

The present invention is further described below by means of examples, but the present invention is not limited to the scope of the described examples. The experimental methods that do not indicate specific conditions in the following examples should be selected according to conventional methods and conditions, or according to product specifications.

### Examples 1-4 and Comparative Examples 1-5

The raw materials of respective Examples and Comparative Examples are prepared according to the composition list of the neodymium-iron-boron magnet materials shown in Table 1, and processed according to the following steps:

(1) Smelting: The prepared raw materials were put into a high-frequency vacuum induction melting furnace with a vacuum degree of 5×10⁻² Pa, and smelt into a molten liquid at a temperature of 1530° C.

(2) Casting: An alloy casting sheet with a thickness of 0.2-0.4 mm was obtained by using the rapid solidification casting method at a casting temperature of 1420° C.

(3) Pulverization: The casting sheet obtained in step (2) was subjected to hydrogen decrepitation pulverization and jet mill pulverization in sequence.

The hydrogen decrepitation pulverization included hydrogen absorption, dehydrogenation and cooling treatment in sequence, in which the hydrogen absorption was carried out under the condition of hydrogen pressure of 0.085 MPa. The dehydrogenation was carried out under the conditions of evacuation while heating, and the dehydrogenation temperature was 500° C.

The jet mill pulverization was carried out when the oxidizing gas (oxygen and moisture) content was 100 ppm or less, and the pressure in the grinding chamber used for jet mill pulverization was 0.70 MPa. The particle size D50 after pulverization was 4.1 μm, D90/D10 was 3.7, and a neodymium-iron-boron magnet material was obtained.

(4) Shaping: A lubricant zinc stearate was added into the neodymium-iron-boron magnet material in an amount of 0.10 wt % of the neodymium-iron-boron magnet material, and then the neodymium-iron-boron magnet material was subjected to magnetic field shaping with a magnetic field strength of 1.8-2.5 T under the protection of a nitrogen atmosphere.

(5) Sintering: The material was subjected to sintering under a vacuum condition of 5×10⁻³ Pa and cooling. The sintering temperature was 1085° C. The sintering time was 6 h. Before cooling, argon gas was introduced to bring the pressure to 0.05 MPa.

(6) Aging treatment: The temperature of the primary aging was 900° C., and the time thereof was 3 h, and then the treated material was cooled to room temperature. Then the temperature of the material was raised for the secondary aging. The temperatures for the secondary aging are shown in Table 2. The time of the secondary aging was 3 h. A neodymium-iron-boron magnet material was obtained.

TABLE 1
The list of the ingredients/% for the neodymium-iron-boron magnet
materials in Examples and Comparative Examples

| Examples/ | | | | | | | | | | | | |
|---|---|---|---|---|---|---|---|---|---|---|---|---|
| Comparative | | | | | | | | | | | | |
| Examples | Nd | Pr | Dy | Al | Cu | Ga | Co | Zr | Nb | Ti | B | Fe |
| Example 1 | 24.75 | 8.25 | / | 1.00 | 0.25 | 0.12 | 0.80 | / | 0.15 | / | 0.98 | Balance |
| Example 2 | 24.00 | 8.00 | / | 0.80 | 0.35 | 0.16 | 0.50 | 0.10 | / | 0.10 | 0.98 | Balance |
| Example 3 | 23.25 | 7.75 | / | 0.50 | 0.50 | 0.18 | 1.00 | / | 0.20 | / | 0.96 | Balance |
| Example 4 | 30.00 | / | 0.20 | 0.30 | 0.50 | 0.10 | 0.50 | / | 0.18 | / | 0.95 | Balance |
| Example 5 | 30.00 | / | 0.20 | 0.30 | 0.60 | 0.10 | 0.50 | / | 0.18 | / | 0.95 | Balance |
| Example 6 | 30.00 | / | 0.20 | 0.30 | 0.50 | 0.05 | 0.50 | / | 0.18 | / | 0.95 | Balance |
| Example 7 | 30.00 | / | 0.20 | 0.30 | 0.75 | 0.05 | 0.50 | / | 0.18 | / | 0.95 | Balance |
| Comparative | 24.75 | 8.25 | / | 1.00 | 0.25 | 0.20 | 0.80 | / | 0.15 | / | 0.98 | Balance |
| Example 1 | | | | | | | | | | | | |
| Comparative | 24.75 | 8.25 | / | 1.00 | 1.00 | 0.3 | 0.80 | / | 0.15 | / | 0.98 | Balance |
| Example 2 | | | | | | | | | | | | |
| Comparative | 24.75 | 8.25 | / | 1.00 | 0.15 | 0.06 | 0.80 | / | 0.15 | / | 0.98 | Balance |
| Example 3 | | | | | | | | | | | | |
| Comparative | 24.75 | 8.25 | / | 1.00 | 0.25 | 0.12 | 0.80 | / | 0.15 | / | 0.98 | Balance |
| Example 4 | | | | | | | | | | | | |
| Comparative | 24.75 | 8.25 | / | 1.00 | 0.25 | 0.12 | 0.80 | / | 0.15 | / | 0.98 | Balance |
| Example 5 | | | | | | | | | | | | |
| Comparative | 30.00 | / | 0.20 | 0.30 | 0.75 | 0.60 | 0.50 | / | 0.18 | / | 0.95 | Balance |
| Example 6 | | | | | | | | | | | | |

Wherein, “/” means that the element was not added. The values of Fe content were obtained by subtracting the contents of other elements from 100%. Those skilled in the art know that the Fe content comprises some inevitable impurities introduced during the preparation process.

### Effect Examples

### 1. Test of Magnetic Properties

By using the closed loop demagnetization curve testing equipment NIM-62000 manufactured by the China Institute of Metrology, the neodymium-iron-boron magnet materials obtained in Examples 1-4 and Comparative Examples 1-5 were tested at a testing temperature of 20° C. to obtain the data on remanence (Br), intrinsic coercivity (Hcj), maximum magnetic energy product (BHmax) and squareness (Hk/Hcj). The testing results are shown in Table 2.

### 2. Characterization of Microstructure

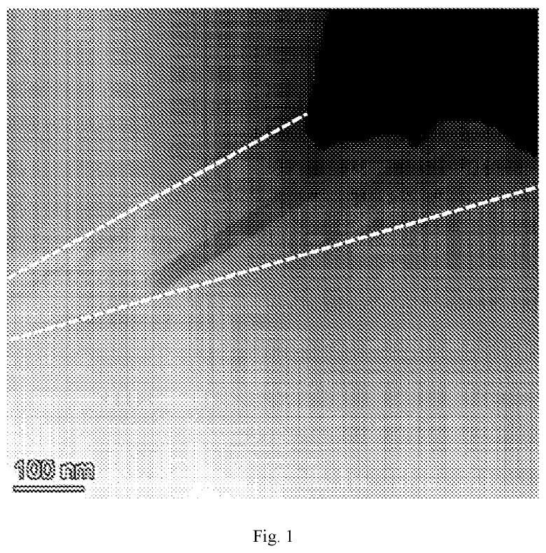

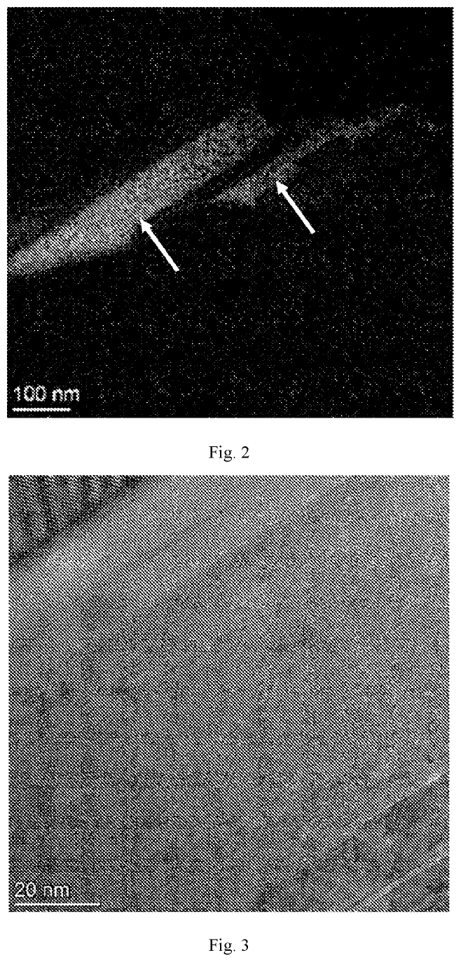

The neodymium-iron-boron magnet materials obtained in the Examples and Comparative Examples were tested by TEM. The SEM pattern of Example 1 is shown in FIG. 1. In FIG. 1, the triangular area marked by the dotted line is an intergranular triangular zone. Then, TEM-EDS element surface distribution scanning was used to find a Cu-rich area, as shown in the blue area in FIG. 2. The areas of the Cu-rich area and the intergranular triangular zone were calculated respectively. The area percentage of the nanocrystalline Cu-rich phase to the intergranular triangular zone was calculated and then converted into a volume ratio percentage. For the same material, its area percentage is the same as its volume percentage. The results are shown in Table 2.

Then, a high-resolution transmission electron microscopy was used to analyze the Cu-rich area. As shown in FIG. 3 (the neodymium-iron-boron magnet material obtained in Example 1), the textures with different orientations represent different crystal grains, and each unit with the same texture orientation represents a crystal grain in a Cu-rich area. It can be seen that the grain size is in a nanometer range.

### 3. Analysis of the Components of the Nanocrystalline Cu-Rich Phase

TEM-EDS (energy dispersion) analysis was used to quantitatively analyze the components of the nanocrystalline Cu-rich phases in respective Examples and Comparative Examples. The results are shown in Table 2 respectively.

TABLE 2
Data for the ingredients of the neodymium-iron-boron magnet
materials and the results of the magnetic properties

| | | | Volume | | | | | |
|---|---|---|---|---|---|---|---|---|
| | | | Percentage of | | | | | |
| | | | Nanocrystalline | | | | | |
| | | | Cu-Rich | | | | | |
| | Temperature | | Phase in | Composition of | | | | |
| Example/ | for | Cu/Ga | Intergranular | Nano-Cu-Rich | Magnetic Properties | | | |
| Comparative | Secondary | (Mass | Triangular | Phase | Bᵣ | H_{cJ} | BHmax | |
| Example | Aging/° C. | Ratio) | Zone/% | (Atomic Ratio/%) | (kGs) | (kOe) | (MGOe) | Hₖ/H_{cJ} |
| Example 1 | 440 | 2.08 | 4.5 | Fe₇RE₃₉Cu₄₅Ga₉ | 13.01 | 26.20 | 40.30 | 0.99 |
| Example 2 | 440 | 2.19 | 6.1 | Fe₁₂RE₂₆Cu₅₈Ga₄ | 13.43 | 25.60 | 42.94 | 0.99 |
| Example 3 | 480 | 2.78 | 4.2 | Fe₁₄RE₃₂Cu₅₂Ga₂ | 13.97 | 23.50 | 46.47 | 0.98 |
| Example 4 | 460 | 5 | 8.5 | Fe₁₀RE₅₀Cu₃₃Ga₇ | 14.38 | 20.10 | 49.23 | 0.99 |
| Example 5 | 460 | 6 | 7.5 | Fe₁₃RE₃₈Cu₄₂Ga₇ | 14.37 | 20.40 | 50.12 | 0.99 |
| Example 6 | 460 | 10 | 6.6 | Fe₁₄RE₃₄Cu₄₂Ga₁₀ | 14.38 | 20.0 | 49.25 | 0.99 |
| Example 7 | 460 | 15 | 7.8 | Fe₁₅RE₄₄Cu₃₁Ga₁₀ | 14.33 | 21.0 | 49.85 | 0.99 |
| Comparative | 450 | 1.25 | None | / | 13.00 | 25.00 | 40.24 | 0.94 |
| Example 1 | | | | | | | | |
| Comparative | 450 | 3.5 | None | / | 12.95 | 24.80 | 39.93 | 0.88 |
| Example 2 | | | | | | | | |
| Comparative | 450 | 2.5 | 1.8 | Fe₁₂RE₄₂Cu₃₆Ga₁₀ | 12.99 | 24.70 | 40.18 | 0.92 |
| Example 3 | | | | | | | | |
| Comparative | 500 | 2.08 | None | / | 13.02 | 24.60 | 40.36 | 0.94 |
| Example 4 | | | | | | | | |
| Comparative | 430 | 2.08 | None | / | 13.00 | 24.40 | 40.24 | 0.93 |
| Example 5 | | | | | | | | |
| Comparative | 460 | 1.2 | None | / | 14.27 | 18.60 | 49.40 | 0.89 |
| Example 6 | | | | | | | | |

In the ingredients of the nanocrystalline Cu-rich phase in Table 2, the numbers represent the atomic percentages of respective elements.

It can be seen from Table 2 that in the neodymium-iron-boron magnet materials produced by the present invention, a nanocrystalline Cu-rich phase having a specific area percentage was formed in the intergranular triangular zone. The inventor found through research that when the area percentage is 3-8, the neodymium-iron-boron magnet materials have excellent magnetic properties. That is, when no heavy rare earth elements are added or less heavy rare earth elements are added and the remanence is higher than 13 kGs, or even as high as 14.38 kGs, the intrinsic coercivity is higher than 20 kOe, or even as high as 26.20 kOe. At the same time, its magnetic energy product and squareness performance are better. The magnetic energy product can be greater than 40.30 MGOe, or even as high as 49.23 MGOe, and the squareness is higher than 0.98, or even as high as 0.99.

Comparative Example 1 does not meet the range of 2≤Cu/Ga≤6 defined in the present invention, which makes it impossible to form a nanocrystalline Cu-rich phase in the intergranular triangular zone of the neodymium-iron-boron magnet material, so that when the remanence is 13 kGs, the intrinsic coercivity is only 25 kOe, which is not as good as the present invention. Comparative Example 2 indicates that when the Cu/Ga range of the present invention is met but the Cu content is too high, the nanocrystalline Cu-rich phase cannot be formed. Accordingly, the remanence and intrinsic coercivity of the obtained neodymium-iron-boron magnet material are significantly worse than those of the present invention, and the magnetic energy product and squareness are also worse than those of the present invention. Comparative Example 3 indicates that when the Cu/Ga range of the present invention is met but the Cu content is too low, although a nanocrystalline Cu-rich phase can be formed, the area percentage of the nanocrystalline Cu-rich phase is too small. Accordingly, the remanence and intrinsic coercivity of the obtained neodymium-iron-boron magnet material are significantly worse than those of the present invention, and the magnetic energy product and squareness are also worse than those of the present invention. Comparative Examples 4 and 5 indicate that when both of the Cu content and Cu/Ga meet the range defined by the present invention, if the temperature for the secondary aging is too high or too low, the nanocrystalline Cu-rich phase also cannot be formed. The magnetic properties such as remanence, intrinsic coercivity, magnetic energy product and squareness or the like of the corresponding neodymium-iron-boron magnet materials are all significantly worse than those of the present invention. Compared with Example 7, Comparative Example 6 only differs in Cu/Ga. The nanocrystalline Cu-rich phase cannot be formed in the obtained neodymium-iron-boron magnet material of Comparative Example 6. The remanence thereof is 14 kGs or more but the intrinsic coercivity thereof is significantly worse than that of the present invention.

1. A neodymium-iron-boron magnet material, comprising a nanocrystalline Cu-rich phase located in an intergranular triangular zone,
the nanocrystalline Cu-rich phase consists of elements TM, RE, Cu and Ga at an atom ratio of TM:RE:Cu:Ga=(1-20):(20-55):(25-70):(1-15),
wherein a volume percentage of the nanocrystalline Cu-rich phase in the intergranular triangular zone is 4-12%, and
wherein TM comprises Fe and/or Co, and RE is a rare earth element.

2. The neodymium-iron-boron magnet material according to claim 1, wherein:
the TM is Fe and/or Co; and/or
in the nanocrystalline Cu-rich phase, the TM has an atom percentage of 5-15%; and/or
in the nanocrystalline Cu-rich phase, the RE has an atom percentage of 25-55%; and/or
in the nanocrystalline Cu-rich phase, the Cu has an atom percentage of 30-60%; and/or
in the nanocrystalline Cu-rich phase, the Ga has an atom percentage of 1-10%; or
the nanocrystalline Cu-rich phase consists of Fe₅₋₁₅RE₂₅₋₄₀Cu₄₅₋₆₀Ga₂₋₉, wherein numbers are atomic percentages of respective elements; or
the nanocrystalline Cu-rich phase consists of Fe₁₀₋₁₅RE₃₀₋₅₀Cu₃₀₋₄₄Ga₇₋₁₀, wherein numbers are atomic percentages of respective elements; or
the nanocrystalline Cu-rich phase consists of Fe₇RE₃₉Cu₄₅Ga₉, Fe₁₂RE₂₆Cu₅₈Ga₄, Fe₁₄RE₃₂Cu₅₂Ga₂, Fe₁₀RE₅₀Cu₃₃Ga₇, Fe₁₃RE₃₈Cu₄₂Ga₇, Fe₁₄RE₃₄Cu₄₂Ga₁₀ or Fe₁₅RE₄₄Cu₃₁Ga₁₀,
wherein numbers are atomic percentages of respective elements.

3. The neodymium-iron-boron magnet material according to claim 1, wherein the volume percentage of the nanocrystalline Cu-rich phase in the intergranular triangular zone is 4-9%.

4. A neodymium-iron-boron magnet material, comprising the following components of Cu: 0.20-0.9 wt %; and Ga: 0.02-0.35 wt %,
wherein contents of Cu and Ga satisfy 2≤Cu/Ga≤15,
wherein the Cu and the Ga represent a mass percentage of Cu and Ga respectively, the mass percentages are mass percentages in the neodymium-iron-boron magnet material, and a total content of all components in the neodymium-iron-boron magnet material is 100%.

5. The neodymium-iron-boron magnet material according to claim 4, wherein:
the Cu has a content of 0.25-0.8 wt %; and/or
the Ga has a content of 0.05-0.2 wt %; and/or
the neodymium-iron-boron magnet material further comprises a rare earth element RE;
the RE has a mass percentage of 28-35 wt % in the neodymium-iron-boron magnet material; the RE comprises Nd and Pr; the Nd has a content of 23-32 wt %; the Pr has a content of 7-9 wt %; the RE further comprises Dy; the Dy has a content of 0.1-0.5 wt %; and/or
the Al has a content of 0.05-2 wt %; and/or
the neodymium-iron-boron magnet material further comprises B; the B has a mass percentage of 0.85-1.1 wt % in the neodymium-iron-boron magnet material; and/or
the neodymium-iron-boron magnet material further comprises Fe; the Fe has a mass percentage of 60-70 wt % in the neodymium-iron-boron magnet material; and/or
the neodymium-iron-boron magnet material further comprises Co; the Co has a mass percentage of 0.1-3 wt % in the neodymium-iron-boron magnet material; and/or
the neodymium-iron-boron magnet material further comprises Zr; the Zr has a mass percentage of 0.05-1 wt % in the neodymium-iron-boron magnet material; and/or
the neodymium-iron-boron magnet material further comprises Ti; the Ti has a mass percentage of 0.05-1 wt % in the neodymium-iron-boron magnet material; and/or
the neodymium-iron-boron magnet material further comprises Nb; the Nb has a mass percentage of 0.1-0.3 wt % in the neodymium-iron-boron magnet material.

6. The neodymium-iron-boron magnet material according to claim 4, wherein:
the neodymium-iron-boron magnet material comprises the following components by mass % of Nd: 23-25%, Pr: 7-9%, Al: 0.4-1.2%, Cu: 0.25-0.50%, Ga: 0.12-0.18%, Co: 0.70-1.50%, Zr: 0-0.2%; Nb: 0-0.20%, Ti: 0-0.1%, B: 0.96-0.98%; and a balance of Fe; or
the neodymium-iron-boron magnet material comprises the following components by mass % of Nd: 28-32%, Dy: 0.1-0.3%, Al: 0.2-0.5%, Cu: 0.50-0.80%, Ga: 0.05-0.10%, Co: 0.40-0.60%, Nb: 0.15-0.20%, B: 0.90-0.96% and a balance of Fe; or
the neodymium-iron-boron magnet material comprises the following components by mass % of Nd: 24.75%, Pr: 8.25%, Al: 1.00%, Cu: 0.25%, Ga: 0.12%, Co: 0.80%, Nb: 0.15%, B: 0.98% and Fe: 63.7%; or
the neodymium-iron-boron magnet material comprises the following components by mass % of Nd: 24.00%, Pr: 8.00%, Al: 0.80%, Cu: 0.35%, Ga: 0.16%, Co: 0.50%, Zr: 0.10%, Ti: 0.10%, B: 0.98% and Fe: 65.01%; or
the neodymium-iron-boron magnet material comprises the following components by mass % of Nd: 23.25%, Pr: 7.75%, Al: 0.50%, Cu: 0.50%, Ga: 0.18%, Co: 1.00%, Nb: 0.20%, B: 0.96% and Fe: 65.66%; or
the neodymium-iron-boron magnet material comprises the following components by mass % of Nd: 30.00%, Dy: 0.20%, Al: 0.30%, Cu: 0.50%, Ga: 0.10%, Co: 0.50%, Nb: 0.18%, B: 0.95% and Fe: 67.27%; or
the neodymium-iron-boron magnet material comprises the following components by mass % of Nd: 30.00%, Dy: 0.20%, Al: 0.30%, Cu: 0.60%, Ga: 0.10%, Co: 0.50%, Nb: 0.18%, B: 0.95% and Fe: 67.17%; or
the neodymium-iron-boron magnet material comprises the following components by mass % of Nd: 30.00%, Dy: 0.20%, Al: 0.30%, Cu: 0.50%, Ga: 0.05%, Co: 0.50%, Nb: 0.18%, B: 0.95% and Fe: 67.32%; or
the neodymium-iron-boron magnet material comprises the following components by mass % of Nd: 30.00%, Dy: 0.20%, Al: 0.30%, Cu: 0.75%, Ga: 0.05%, Co: 0.50%, Nb: 0.18%, B: 0.95% and Fe: 67.07%.

7. The neodymium-iron-boron magnet material according to claim 4, wherein the neodymium-iron-boron magnet material comprises a nanocrystalline Cu-rich phase located in an intergranular triangular zone,
wherein the nanocrystalline Cu-rich phase consists of elements TM, RE, Cu and Ga at an atom ratio of TM:RE:Cu:Ga=(1-20):(20-55):(25-70):(1-15); and
wherein a volume percentage of the nanocrystalline Cu-rich phase in the intergranular triangular zone is 4-12%, and
wherein TM comprises Fe and/or Co, and RE is a rare earth element.

8. A preparation method for a neodymium-iron-boron magnet material comprising following steps of preparing a magnet blank from the respective components of the neodymium-iron-boron magnet material according to claim 4; and subjecting the magnet blank to an aging treatment to achieve the neodymium-iron-boron magnet material,
wherein the aging treatment comprises a primary aging and a secondary aging, and the secondary aging is performed at a temperature of 440-480° C.,
wherein the primary aging is performed at a temperature of 800-1200° C.;
wherein the primary aging is performed for a time of 2-4 h;
wherein when the primary aging is completed, the magnet blank is cooled to room temperature and then subjected to the secondary aging;
wherein the secondary aging treatment is performed at a temperature of 440° C., 450° C., 460° C. or 480° C.;
wherein the secondary aging treatment is performed for a time of 2-4 h;
wherein the preparation method for the magnet blank comprises subjecting the respective components for the neodymium-iron-boron magnet material to smelting, casting, pulverization, shaping and sintering in turn;
wherein the smelting is performed at a temperature of 1550° C. or less;
wherein the smelting is carried out in a vacuum environment;
wherein the smelting is carried out according to a rapid solidification casting method;
wherein the smelting is performed at a temperature of 1390-1460° C.;
wherein the pulverization comprises hydrogen decrepitation pulverization and jet mill pulverization in turn; the hydrogen decrepitation pulverization comprises hydrogen absorption, dehydrogenation and cooling treatments; the hydrogen absorption is performed at a hydrogen pressure of 0.05-0.12 MPa; the dehydrogenation comprises heating to 300-600° C. under a vacuum condition; the jet mill pulverization is carried out in an atmosphere with an oxidizing gas content of no more than 100 ppm; the jet mill pulverization is performed in a grinding chamber having a pressure of 0.5-1 MPa; the magnet blank obtained after the jet mill pulverization has a particle size D50 of 3-6 μm;
wherein the shaping is magnetic field shaping; the magnetic field shaping is carried out under a magnetic field intensity of 1.8-2.5 T; and the magnetic field shaping is carried out in a protective atmosphere; and
wherein a lubricant is added to a powder obtained after the pulverization before the shaping; the lubricant is zinc stearate; the lubricant has a mass percentage of 0.05-0.15% in the powder obtained after the pulverization; the sintering is carried out in a vacuum environment; the sintering is performed at a temperature of 1000-1100° C.; and the sintering is performed for a time of 4-8 hours.

9. A neodymium-iron-boron magnet material prepared by the preparation method according to claim 8.

10. Use of the neodymium-iron-boron magnet material according to claim 1 as an electronic component in a motor.
